(19) United States
(12) Patent Application Publication
(10) Pub. No.: US 2025/0011697 A1
(43) Pub. Date: Jan. 9, 2025

(54) APPARATUS AND PROCESS FOR THE PRODUCTION OF WORT

(71) Applicant: MEURA S.A., PERUWELZ (BE)

(72) Inventors: François DEROUBAIX, TOURNAI (BE); Frédérique HARMEGNIES, BURDINNE (BE); Michel THIROT, SIRAULT (BE); Christian DE BRACKELEIRE, STERREBEEK (BE)

(21) Appl. No.: 18/711,030

(22) PCT Filed: Nov. 21, 2022
(86) PCT No.: PCT/EP2022/082531

§ 371 Date: May 16, 2024

(30) Foreign Application Priority Data
Nov. 22, 2021 (BE) BE2021/5902

(51) Int. Cl. C12C 7/04; B02C 13/16; B02C 13/28; C12C 7/01; C12C 7/06

(52) U.S. Cl. CPC C12C 7/042; B02C 13/16; B02C 13/28; C12C 7/01; C12C 7/06; B02C 2013/2808

(57) ABSTRACT

An impact mill-includes a casing enclosing a milling chamber; at least one rotor, impacting elements driven in rotation by the rotor; wherein the casing has an inlet for the raw material and an outlet for the milled material, and wherein the casing is equipped with water injectors.

### TECHNICAL FIELD OF THE INVENTION

The present invention relates to a method for the production of wort, in particular from green malt or any other germinated cereal.

The present invention also relates to a device, in particular for milling green malt or any germinated cereal.

The production of wort is a necessary step for several industries, especially in the brewing, distilling or any other industry related to the manufacture of extracts or beverages or foods prepared from cereals.

### INTRODUCTION

A process for wort production typically involves the following steps: Starch-containing raw materials are pre-milled and/or mixed with water; it is the milling and mashing operations that lead to the obtaining of a suspension called “mash”.

The mash is then brought to different temperature levels to allow the enzymes to convert the starch into sugars, this is the brewing operation.

At the end of the brewing process, the mash is filtered to separate the insoluble materials (spent grains) from the wort. This is usually done using a lauter tun or filter press.

The use of a membrane thin-film filter press such as that manufactured by the Applicant, or equivalent technology, requires a fine milling of the raw materials. In this case, the milling operation aims to obtain a particle size distribution centred between 125 μm and 1 mm, preferably with a minimum of 60% of the particles located in this particle size range.

The wort then undergoes a treatment that depends on the final product to be manufactured. In the brewing process, the filtered wort is subjected to a boiling step. During this stage, hops are added to the wort, which is then clarified before cooling and transferred to fermentation.

This process can be carried out in batch, continuous or semi-continuous mode.

The raw materials used to produce wort can be varied and include cereals or pseudo-cereals, raw or malted. For producing beer, recipes usually include “malt”. “Malt” is a cereal, usually barley, that has undergone the operations of soaking, germination, kilning and degermination. The term ‘malt’ is used here in its broad sense to describe “malted cereals”. It therefore concerns barley, but also includes other cereals such as wheat, rye, oats, sorghum, etc. Soaking is a preparatory step for germination, allowing the hydration of the grains to increase the percentage of humidity to around 45%. Then germination can start. This phase lasts from 3 to 5 days, during which the malt enzymes are produced. At the end of germination, the enzymatic power of the malt, called “green malt” at this stage, is at its maximum. Due to its high humidity, green malt is microbiologically unstable, making it impossible to store and transport. Kilning is a drying operation that transforms “green malt” with about 40 to 50% moisture, into malt with a moisture content of about 4%. During kilning, the enzymatic power of the malt is reduced because many enzymatic activities are stopped.

There is an interest in producing wort from “green malt” or other germinated cereals, with limited or no kilning.

The advantage of using green malt is, on the one hand, to reduce the energy consumption of the manufacturing process by completely or partially eliminating the kiln step, and on the other hand, to take advantage of the maximum enzymatic power of the raw material to optimize the wort manufacturing process (saving time for the conversion of starch into sugars during the brewing operation).

However, there are some difficulties in using this raw material:
Green malt is not microbiologically stable and can not be stored for more than a few days. It must therefore be put into process quickly after germination;
Green malt, due to its high humidity and the presence of rootlets from germination, greatly complicates the process steps upstream of brewing, especially milling. Indeed, in a grain that is 40-50% moist, the rootlets and husks have a lower brittleness, or even a certain elasticity that makes them difficult to mill by the usual techniques.

### BACKGROUND OF THE INVENTION

The use of green malt has already been described since the beginning of the last century. Document GB 190914266 describes a process for preparing a malt extract. The milling of green malt is carried out with millstones.

FR 356 024 A describes a rudimentary mill for milling green malt. It uses a rotary cutter attached to the rotor and arranged against a perforated plate. The knife scrapes the perforated plate. This is not an impact mill.

However, these very old technologies did not allow the industrial production of beer according to these processes.

Document WO 03/048294 A1 describes a method of stabilising green malt for the brewing industry, allowing its preservation while avoiding the energy expenditure of kilning. The milling step is done using a disc mill.

Document WO 2021/099867 A1 describes a method and device for optimising the use of green malt in a brewing process. The device includes a first step of cutting the grains before they are milled, followed by a second stage where the fragmented green malt is ground between 2 stones. The 2-step sequential process is complex and requires additional equipment that increases the cost of production of the wort.

Document FR 3 042 721 A1 describes a grain mill for animal food. It comprises hitting elements Cx, rectangular-shaped, freely-mounted that rotate on axes. This mill is not suitable for milling green malt. It works in a dry process.

Patent EP 0 845 528 B1, in the name of the Applicant, describes a milling process for obtaining a fine milling. The process uses a disc mill, under water. However, with green malt, this type of milling has capacity and efficiency issues. Because the wet husks of green malt are “elastic”, they have proven to be more difficult to mill than those of malt or other malted materials. This capacity limitation makes the application unusable for industrial brewhouses, and the investment and operating costs are very high. Since the disc mill works on the principle of friction, it is difficult to achieve a sufficient reduction in particle size, especially if it meets the prerequisites for optimal operation of the thin-film filter press.

### SUMMARY OF THE INVENTION

One purpose of the invention is to produce wort from green malt or any germinated grain, having a moisture content greater than 15%, preferably above 20%. This saves the energy-intensive kiln step and takes advantage of the high enzymatic power of green malt.

In particular, the purpose of the invention is to remedy the problems encountered in milling green malt.

The aim is also to provide a mill suitable for milling green malt.

The aim of the invention is also to produce a beer resulting from the fermentation of wort obtained from green malt.

The Applicant commercialises impact mill of the type hammer mills to produce fine milling from raw or malted cereals, with a moisture content of between 3 and 15%.

This type of mill consists of a milling chamber, comprising an inlet and outlet for the material, one or more rotors, preferably with a horizontal axis, on which discs supporting hammers are mounted. The rotor operates with a rotational speed that gives the hammers a high peripheral speed, preferably in the order of 100 m/sec. The lower part of the milling chamber has a sieve, i.e. a perforated plate. The size of the perforations of the sieve is chosen according to the target particle size, as well as the friability of the raw materials. For malt milling, depending on the size of the mill, sieves with perforations from 1.5 mm to 4 mm in diameter can be used.

The milling chamber is connected to a forced ventilation unit.

This type of mill has never been used as such for green malt. The maximum moisture content of the grains to be milled is 15%. Beyond this humidity level, problems with clogging of the screens appear.

The present invention therefore relates to an impact mill, in particular for milling green malt, comprising:
a casing enclosing a milling chamber;
at least one rotor;
impacting elements driven in rotation by the rotor;
the casing has an inlet for the raw material and an outlet for the milled material; the casing is equipped with water injectors.

In particular, the milling chamber has a sieve.

In the case of a rotor in a horizontal position, the sieve can be advantageously placed in the lower part of the milling chamber.

In particular, at least one injector is positioned in such a way that water is fed directly into the milling chamber (without passing through the sieve). In the case of a horizontal axis mill, this injection is placed in the upper part of the milling chamber. Other injectors are placed in such a way as to bring water behind the sieve, i.e. in the lower part of the milling chamber if the mill has horizontal axis.

Some of the impacting elements can be hammers and others can be sharpened in the shape of knives.

Advantageously, the impacting elements are mounted in a pivotal manner on axes that are rotated by the rotor. The mill can hold several axes, preferably 4 to 8, in a way still preferred 4 axes.

On the same axis, there can be hammers and knives, e.g. the first and last impacting elements are knives and the other impacting elements are hammers. Any other arrangement is possible. For example, alternating knives and hammers or a majority of knives.

The axes carrying the knives are driven by the rotor using support parts, which can be discs but any other shape can be considered.

Spacer elements can be positioned between each impacting element.

Advantageously, the sieve has perforations between 1.0 mm and 4.0 mm, preferably between 2 mm and 3 mm.

The present invention also relates to the use of a mill as described above, for the milling of green malt or any other germinated cereal having in particular a moisture content of more than 15%, preferably more than 20%, or even between 40 and 50%.

The present invention also relates to a process for producing a wort, characterised in that green malt or any other germinated cereals is fed into a impact mill and simultaneously undergoes the milling and mashing operations.

Advantageously, the method according to the invention uses a mill as described above.

In particular, mash water is introduced through injectors. The total amount of mash water introduced results in a ratio (water/green malt) of between 0.5 and 3.0, preferably 1 to 2.0 L/kg.

Preferably, some of the mash water is introduced through injectors placed in the upper part of the mill and another part of the mash water is introduced through injectors placed in the lower part of the mill.

Advantageously, the duration of the milling/mashing operation is a maximum of 45 minutes, preferably between 10 and 30 minutes.

The mash water can be introduced at a temperature between 2° and 95° C., preferably between 4° and 70° C., and preferably between 45 and 60° C.

The pH of the mash obtained by the method of the invention, after mashing, is generally between 5.2 and 5.6.

In particular, the milling/mashing operation is carried out at a peripheral rotation speed of between 50 and 150 m/sec, preferably between 80 and 120 m/sec, preferably at a speed of around 100 m/sec.

The milling/mashing step of the process according to the invention advantageously allows the production of a fine milling suitable for the filtration of wort on a membrane filter press.

The present invention also relates to a beer produced from a wort obtained with the process described above and/or with the mill described above.

### BRIEF DESCRIPTION OF FIGURES

These and other aspects of the invention will be clarified in the detailed description of a particular embodiment of the invention, with reference to the drawings of the figures, in which:

FIG. 1 is a general view of a mill and its ancillary accessories;

FIGS. 2 and 3 are sections of the inside of the mill;

FIG. 4 is a perspective detail view of part of the mill;

FIG. 5 is a detailed view of two embodiments of the knife.

### DETAILED DESCRIPTION OF A PARTICULAR EMBODIMENT OF THE INVENTION (EQUIPMENT)

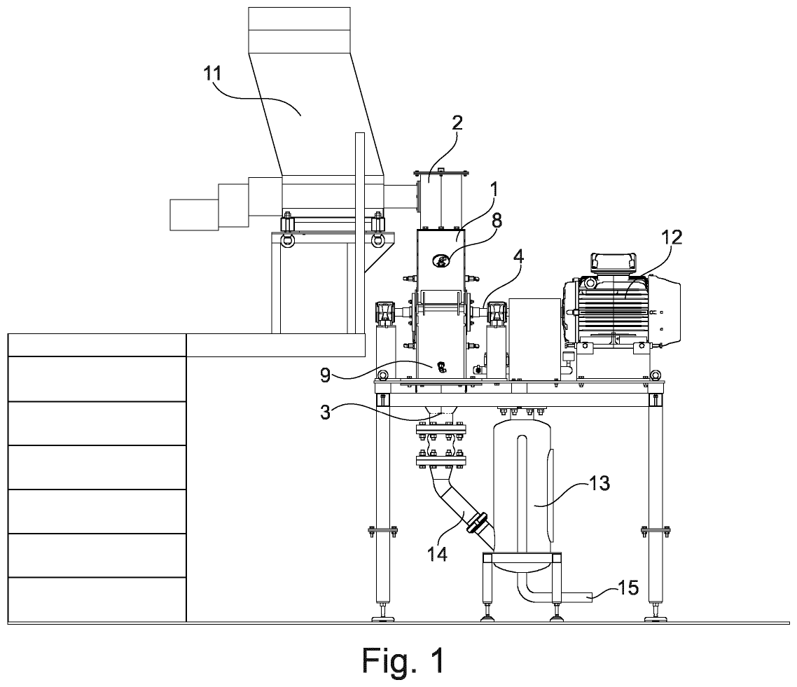

FIG. 1 illustrates all the elements of a mill according to the invention.

A feed hopper 11 is used to feed the material to be milled at mill 1. A motor 12 drives a rotor 4. The milled material flows through a piping 14 to a buffer tank 13 and then is fed to the brewing vessel through a piping 15. One can also consider the configuration in which the mill is placed above the brew tank. In this case, the milled material flows directly into the tank.

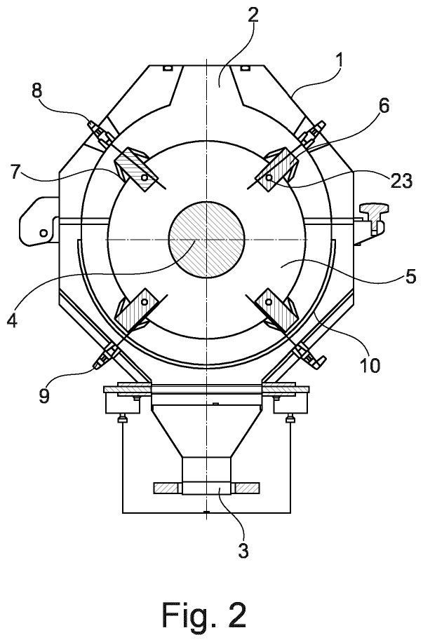

In FIGS. 2 to 4 (example of realisation 2), it can be seen that mill 1 consists of a milling chamber, comprising an inlet 2 for the green malt grains and an outlet 3 for the milled material, a rotor 4 with a horizontal axis, on which discs 5 are mounted. The number of discs depends on the capacity of the mill, and therefore on the size of the milling chamber. The discs are drilled at their periphery for the passage of transverse axes 23. Impacting elements are suspended in a pendulum manner on the axes 23 going through the discs 5.

The impacting elements can be 6 hammers and/or 7 knives. They can come in different shapes and materials. The illustrated embodiment uses hammers 6 of rectangular shape, and bevelled knives 7, made of stainless steel.

For the sake of clarity, the impacting elements are shown as they rotate.

In reality, when rotating, the impacting elements do not remain fixed in this position but can rotate on the axis.

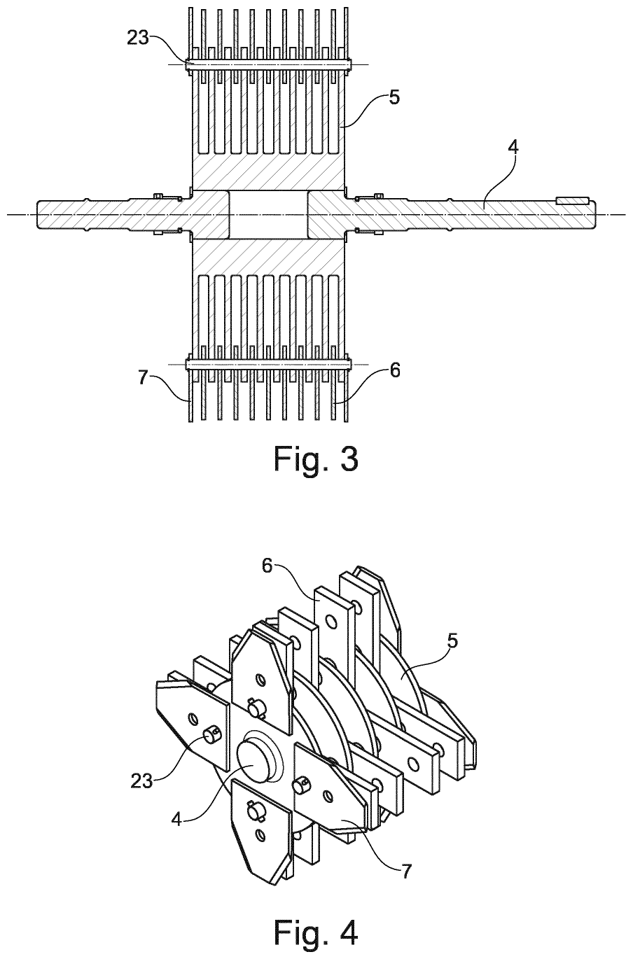

In FIG. 4, we can see an embodiment with four axes 23 and thus four rows of impacting elements. The first and last item in each row are knives 7. Rectangular-shaped hammers 6 are arranged between each disc.

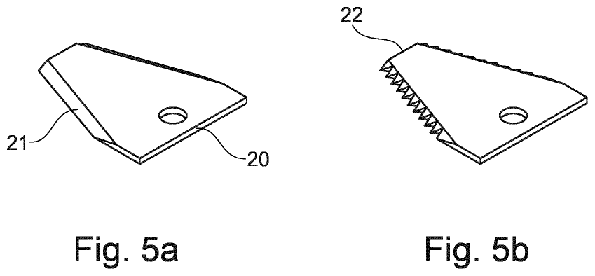

As shown in FIG. 5, the knives 7 are rectangular in shape, with the two corners at the periphery cut and sharpened. The knives 7 therefore have six sides: a rectangular base 20 directed towards the rotor 4, a distal end with two oblique sides 21 and a flat top 22.

The oblique sides 21 are sharpened in such a way that their thickness is reduced. Sides 21 may be smooth (FIG. 5a) or toothed (FIG. 5b).

Rotor 4 operates with a standard rotational speed giving the hammers a high peripheral speed, preferably between 80 and 120 m/sec, more preferably in the order of 100 m/sec. The rotor works alternately in the horological and anti-horological directions in such a way as to cause symmetrical wear on the sides of the impacting elements. The lower part of the milling chamber is equipped with a sieve 10, i.e. a curved perforated plate. The outward-facing side of the sieve of the milling chamber is called the back side; the front side being the one facing the rotor. For application to germinated cereals, the size of the perforations of the sieves can be between 1 mm and 4 mm.

The milling chamber contains water injectors 8 and 9 placed at different locations. In the example of implementation, the water injectors have flat or conical spray heads. The number of water injectors depends on the size of the milling chamber. At least one water injector 8 is located at the top of the milling chamber, on the side of the raw material feed (or inlet 2). This injector 8 sprays water directly into the milling chamber. Its role is to provide a flow of water that allows the raw material (green malt) to be carried away and to facilitate the passage of the milled grains through the perforated sieve 10. In the example of implementation, the number of injectors at the top of the chamber is four. These water injectors 8 will be referred to as “main”. The quantity of water injected is calculated in proportion to the flow rate of green malt, so as to respect the ratio necessary to obtain the desired wort density. To obtain a dense wort between 2° and 24° Plato, this flow rate will be 1 to 1.5 L/kg to take into account the significant amount of water contained in the green malt grains. When there are multiple water injectors, the water flow is divided between the different injectors.

The lower part of the milling chamber, which collects the milled raw material after passing through the perforated sieve 10, also contains at least one water injector 9, called the “secondary” injector. The example includes four injectors placed in this area of the milling chamber. These injectors 9 spray water on the back side of the sieve 10. The role of these injectors is to ensure that the underside of the sieve 10 is cleaned, during and after the milling operation.

The combined action of the injectors 8 and 9 located at different points in the milling chamber allows the raw material to be driven through the sieve 10 and prevents accumulation and clogging on either side of the sieve.

The total amount of water used during the milling operation is calculated in such a way as to keep a reserve for rinsing the milling chamber and the underside of the sieve 10 once the raw material has passed. The total amount of water feeding the main and secondary injectors is considered to be green malt mash water: it is therefore a process water, at the desired temperature for mashing the brew, which can be corrected at the level of its pH, and contains additives usually incorporated in the mashing water such as enzymes or salts, etc.

The material that comes out of the mill consists of the milled green malt suspension and the mash water. It is pumped directly into a stirred tank to initiate brewing. The operation therefore combines the two stages of milling and mashing into one. This should therefore be carried out over a maximum duration of 45 minutes, preferably between 10 and 40 minutes, more preferably between 15 and 30 minutes. The capacity of the mill will have to be calculated taking this aspect into account.

According to another advantageous embodiment the equipment has a larger capacity.

The mill used is an impact mill equipped with an 18.5 kW motor running at 3000 rpm. This motor directly drives the horizontal axis of rotation (or rotor 4) of the mill, on which ten identically spaced discs 5 are attached. Each of these discs 5 has four circular holes arranged at 90° from each other into which metal bars, or axis 23, are inserted with pivotally mounted impacting elements. The motor drives four rows of eleven impacting elements rotating at a peripheral speed of 100 m/s.

The installed sieve 10 has perforations of 2.5 mm in diameter.

Other arrangement could, of course, be envisaged without going beyond the scope of the present invention. The rotor of the mill can be in a horizontal position rather than a vertical one. In this case, the vertical sieve can also cover the entire periphery of the milling chamber. Some of the injectors will preferably be designed to inject water directly into the milling chamber and others to inject water behind the sieve.

### EXAMPLES OF THE METHOD ACCORDING TO THE INVENTION

### Example 1

Example 1 details a method of producing wort from green malt using a wet hammer mill as described below.

### Green Malt

The green malt used in this trial is made from spring barley of the “Sébastien” variety that has undergone the stages of malting until germination, which is stopped after 5 days. The green malt obtained in this way has a moisture content of between 37 and 43%.

### Milling/Mashing

The pilot mill used is a hammer mill equipped with a 9.2 kW motor running at 2900 rpm. This motor drives the horizontal axis of rotation of the mill (rotor 4), to which five identically spaced discs 5 are attached. Each of these discs has four circular holes arranged at 90° from each other into which metal bars 23 equipped with hammers 7 mounted in a pivotal manner are inserted. The motor drives four rows of six hammers rotating at a peripheral speed of 100 m/s.

The installed sieve has perforations of 2.5 mm in diameter.

A mixture of water and grains is made in the milling chamber.

The water and grain flow rates are set up in such a way that the milling step can be completed in 15 minutes.

The grain feed rate is set between 3 and 5 kg/min by means of a worm at the start of a grain hopper 11, with a water flow rate adapted so as to achieve an instantaneous mashing ratio of between 0.8 and 1.3 L/kg (litre of water per kg of green malt). The mash water temperature is between 45° C. and 55° C.

A certain volume of rinse water is used at the end of the milling process to carry the residual particles out of the milling chamber and clean the sieve 10. This volume of water is set to achieve a total mash ratio of 1.5 L/kg.

In this first example, 37.5 kg of green malt was milled in a wet environment with 56.3 litres of water. All of the green malt was milled in 11.5 minutes, and 7 L of water was used to rinse the milling chamber.

The resulting mash is then pumped from a buffer tank 13 via piping 15 to the brewing tank.

### Wort Production

After correcting the pH to 5.5 with phosphoric acid, the mash obtained after milling under water is subjected to a brewing diagram allowing the enzymes in the green malt to degrade the starch into sugars:
10 min at 45° C.
20 min at 63° C.
20 min at 72° C.
5 min at 78° C.

The heating with a temperature increase of 1° C./min and the temperature rest at the various stages are ensured by direct injection of low-pressure steam into the product.

The mash is then filtered using a three-chamber “Meura 2001 Hybrid Micro” filter with a total nominal capacity of 33 kg of malt. The filtration cycle follows a series of classic steps (filling, filtration, pre-compression, washing, final compression, emptying, discharging spent grain) optimising the parameters in order to obtain 138 L of wort at 12° P.

The turbidity of the wort measured by the Imhoff cone method shows values between 4 and 5 mL/L, which is typical for wort produced from barley malt and filtered on “Meura 2001 Hybrid”.

### Example 2

Example 2 details a method of producing green malt wort identical to that described in example 1, using an impact mill as shown in FIG. 4.

The first and last impacting elements in each row are, in this example, sharpened in the shape of knives 7 as shown in FIG. 5b. They are made of steel, grooved and toothed, of the same length. The other impacting elements placed between each disc 5 are simple rectangular-shaped hammers.

In contrast to example 1, the mill is therefore equipped with a mixture of hammers 7 and knives 6.

At the same power output, the 37.5 kg of green malt was crushed in 10.2 minutes, a time saving of 11% compared to example 1. The replacement of part of the rectangular hammers 6 by knives 7 enabled to increase the milling effect of the rootlets and “elastic” wet husks that characterize green malt.

After brewing and filtration, 128 L of wort at 13° P was obtained. The use of the knives saved 12% of the time on the filtration stage and the wort has a turbidity equivalent to that measured in example 1, between 4 and 5 mL/L.

### Example 3

Example 3 details a method of producing wort based on green malt using a new type of impact mill operating under water as described below.

### Green Malt

The green malt used is of the Planet variety, and underwent the malting stages until the germination phase which lasted 5 days. It has a humidity level of 32%.

### Milling/Mashing

The mill used is a impact mill functioning under water as shown in FIGS. 1 and 2.

The horizontal axis 4 of the mill is driven by an 18.5 kW motor 12 equipped with a frequency converter rotating at 3000 rpm at nominal speed.

The axis 4 supports ten stainless steel discs 5 identically spaced. Each of these discs has four circular holes arranged at 90° from each other into which are inserted metal bars 23 with impacting elements 7 mounted in pivotal manner. The motor drives thereby four rows of eleven impacting elements rotating at a peripheral speed of 100 m/s.

In this example, all the impacting elements are stainless steel knives with a smooth cutting profile as shown in FIG. 5a.

The sieve 10 installed in the lower part of the milling chamber has perforations of 2.5 mm in diameter.

A mixture of grains and water is made in the milling chamber. The grains are fed to the mill from the top of chamber 2 from a grain hopper 11. A buffer installed at the bottom of the hopper 11 allows the grains to be transported to the mill. The hydration of the grains is carried out by injecting water at different points in the milling chamber via nine injectors 8 whose opening is adjusted to achieve an instantaneous water ratio close to 1 L/kg of grains. The mashing water used has a temperature between 45 and 55° C. during milling, and a certain rinse volume is added at the end of the milling process to carry the residual particles out of the chamber and clean the sieve.

In this example, 104 kg of green malt grains were milled at a flow rate of 9.3 kg/min with an instantaneous water flow rate of 9 L/min, resulting in an instantaneous ratio of 1 L/kg. The milling process lasted 11 minutes, and 44 litres of rinse water were added at the end of the milling process to achieve an overall ratio of 1.38 L of water per kg of grain.

The resulting mash is then pumped from a buffer tank 13 via piping 15 to the brewing tank.

### Wort Production

The settings applied to the brew are the same as those described in Example 1. The mash is then filtered using an 8-chamber “Meura 2001 Hybrid Micro” filter with a total nominal capacity of 87.5 kg of malt. The filtration cycle follows a series of classic steps (filling, filtration, pre-compression, washing, final compression, emptying, discharging spent grain) optimising the parameters in order to obtain 396 L of wort at 13° P.

The turbidity of the wort measured by the Imhoff cone method shows values between 2 and 3 mL/L, which is typical for wort produced from barley malt and filtered on “Meura 2001 Hybrid” filter.

### Advantages

The main advantage of the invention is to propose a process for producing wort from green malt, saving the kilning step, which consumes a lot of thermal energy. The use of green malt as a starting material for the production of wort thus reduces production costs.

The invention solved the problems associated with the milling of the rootlets and wet husks that characterize this raw material.

Also, the combination of the milling and mashing steps in a single operation, as well as the high enzymatic potential of green malt promoting enzymatic reactions during brewing, can lead to considerable time savings in the wort production process.

The invention also made it possible to simplify and reduce the encumbering size of the equipment.

The invention is particularly well suited to the continuous production of wort.

Examples of realizations have shown that the placement of knives increases the capacity of the mill in terms of the weight of milled material per kilowatt hour. Several knives can be placed on the rotor discs, as a partial or total replacement for the rectangular hammers.

1. An impact mill comprising:
a casing enclosing a milling chamber;
at least one rotor,
impacting elements driven in rotation by the rotor;
wherein the casing has an inlet for the raw material and an outlet for the milled material, and
wherein the casing is equipped with water injectors.

2. The impact mill according to claim 1, wherein the milling chamber comprises a sieve.

3. The impact mill according to claim 2, wherein one or more injectors of the water injectors are placed in such a way as to feed water directly into the milling chamber.

4. The impact mill according to claim 2, wherein one or more injectors of the water injectors are placed in such a way as to carry water behind the sieve.

5. The impact mill according to claim 1, wherein the impacting elements are hammers and/or knives.

6. The impact mill according to claim 1, wherein the impacting elements are mounted in a pivotal manner on axes driven in rotation by the rotor.

7. The impact mill according to claim 6, comprising 4 to 8 axes.

8. The impact mill according to claim 6, wherein on a same axis the impacting elements are alternately knives and hammers.

9. The impact mill according to claim 6, wherein a majority of the impacting elements are knives.

10. The impact mill according to claim 2, wherein the sieve has perforations a size of which is between 1.0 mm and 4.0 mm.

11. A method comprising providing an impact mill according to claim 1, for milling green malt.

12. A process for producing a wort, comprising feeding green malt or any other germinated cereal with a moisture content of more than 15% into an impact mill and to simultaneously undergoes milling and mashing operations.

13. The process according to claim 12, wherein the impact mill comprises:
a casing enclosing a milling chamber;
at least one rotor,
impacting elements driven in rotation by the rotor;
wherein the casing has an inlet for the raw material and an outlet for the milled material, and
wherein the casing is equipped with water injectors.

14. The method according to claim 13, wherein mash water is introduced by the water injectors.

15. The process according to claim 14, wherein a total amount of mash water introduced is sufficient to obtain a ratio of between 0.5 and 3.0 L/kg.

16. The process according to claim 15, wherein a part of the mashing water is introduced by one or more injectors of the water injectors placed in such a way as to bring the water directly into the milling chamber and another part of the mashing water is introduced by one or more injectors of the water injectors placed behind the sieve.

17. The process according to claim 16, wherein a duration of the milling/mashing operation is a maximum of 45 minutes.

18. The process according to claim 14, wherein the mashing water is introduced at a temperature between 20 and 95° C.

19. The process according to claim 12, wherein the milling/mashing operation is carried out at a peripheral rotational speed of between 80 and 120 m/sec.

20. The impact mill according to claim 6, comprising 4 axes.
